(19) United States
(12) Patent Application Publication
(10) Pub. No.: US 2026/0039548 A1
(43) Pub. Date: Feb. 5, 2026

(54) SYSTEM AND METHOD FOR DYNAMIC UPDATING OF DISPARATE HARDWARE USING DEPLOYED DATA MANAGEMENT AGENTS

(71) Applicants: Apica Inc., El Segundo, CA (US); Circonus, Inc., Malvern, PA (US)

(72) Inventors: William Kevin Krause, Philadelphia, PA (US); David Bernard Haifley, Baltimore, MD (US)

(21) Appl. No.: 18/637,745

(22) Filed: Apr. 17, 2024

Related U.S. Application Data
(60) Provisional application No. 63/459,898, filed on Apr. 17, 2023.
(60) Provisional application No. 63/469,949, filed on May 31, 2023.

(51) Int. Cl. H04L 41/082; G06F 8/65; H04L 41/046; H04L 41/22

(52) U.S. Cl. CPC H04L 41/082; G06F 8/65; H04L 41/046; H04L 41/22

(57) ABSTRACT

The present invention relates generally to distributed computing systems, and more specifically, to a computerized system and method that allows for dynamic updating of distributed hardware using reconfigurable data management agents.

### CROSS-REFERENCE TO RELATED APPLICATIONS

This application claims the benefit of U.S. Provisional Patent Application No. 63/459,898 filed Apr. 17, 2023, and claims the benefit of U.S. Provisional Patent Application No. 63/469,949 filed May 31, 2023, each of which are incorporated herein by reference in its entirety.

### FIELD OF THE INVENTION

The present invention relates generally to distributed computing systems, and more specifically, to a computerized system and method that allows for dynamic updating of distributed hardware using reconfigurable data management agents.

### DISCUSSION OF RELATED ART

Distributed computing systems generally involve hardware, sometimes disparate hardware, that is geographically distributed but interconnected via a data communications network, such as the Internet or a private network.

The field of telemetry involves the automated recording and transmission of data from remote or inaccessible hardware sources to a computerized system in a different location for the purposes of monitoring and analysis. Telemetry data may be relayed using radio, infrared, ultrasonic, GSM, satellite or cable transmission, depending on the application. Telemetry is not only used in software development, but also in meteorology, intelligence, medicine, and other fields.

In the software development world, telemetry can offer insights into which features end users use most, detection of bugs and other issues, and can offer better visibility into performance without the need to solicit feedback directly from users. Telemetry data may also be used to monitor on-premise, cloud and hybrid computing infrastructure, to perform network monitoring, and to perform software application monitoring, all to provide data analytics, technical and/or business intelligence data, and other insights usable for computer resource management purposes.

With continued advancement in the field of the Internet of Things (IoT), and with the continued proliferation of network-connected devices, the volume of available telemetry data is exploding. Generally speaking, telemetry data is becoming increasingly distributed, and is becoming increasingly resource-intensive to ingest, move, manage, and store.

Ultimately, the ability to monitor a system and gather data is only as good as the underlying telemetry system. Yet, existing telemetry tools often limit data volumes (e.g., using tactics like reduced sampling) as a compromise to avoid ingesting a relatively higher volume of data that could be helpful for system monitoring and management purposes, but may also ultimately be unwieldly as a practical matter.

Data pipelines gathering such data from disparate hardware and providing it to a centralized monitoring system are painful and tedious to build and maintain, particularly for people who are not skilled software developers. A wide range of open-source telemetry data plug-ins (software) are available for use in configuring the distributed hardware, but, generally, they each have their own peculiarities, such as data formats, standards, etc. Examples of open-source telemetry plug-ins include offerings available from companies such as Fluentbit, Logstash, Telegraf, OpenTelemetry, and DataPrepper.

A data pipeline may include one or more data input plug-ins, data processing plug-ins, and/or data output plug-ins, each of which may be a discrete open-source software module that requires set-up and/or configuration. A set of one or more plug-ins may be configured to work together, for telemetry data purposes, and collectively form a telemetry data agent. Additionally, set-up and configuration of such telemetry agents (including set-up and configuration of one or more plug-ins) is a manual process, is prone to human error, and thus is not well-suited to performance by people other than skilled software developers. Additionally, such agents are essentially static, in that, after then are setup/configured and deployed to the field (e.g., stored in a memory of a remotely-located computing device), there is a high degree of reluctance to change them, and it is difficult to do so.

What is needed is a solution that can allow easier creation and/or configuration of telemetry agents that lessens the need for use of skilled software developer resources, and that allows for flexibility in system monitoring and/or telemetry data management.

### SUMMARY OF THE INVENTION

The present invention provides a system and method that allows for easier creation and/or configuration of telemetry agents (and associated plug-ins), and therefore lessens the need for use of skilled software developer human resources. Additionally, the present invention provides a system and method that allows for flexibility in system monitoring and/or telemetry data management. More particularly, the present invention provides a system and method that provides a low-code and/or no-code visual designer graphical user interface usable by laypersons to create and/or configure telemetry data management agents that govern data collection, storage, transmission, etc. at a computerized endpoint device. Further, the present invention provides a system and method that provides for dynamic updating of disparate hardware to modify the nature and/or quantity of telemetry data collected, and/or otherwise manage telemetry data storage, transmission, etc., by allowing for dynamic updating of deployed telemetry data management agents—even after initial deployment of such agents. Accordingly, for example, the present invention reduces the need for skilled software developer resources to perform these functions, and empowers others that are not skilled software developers, such as layperson members of the Operations, DevOps and Site Reliability Engineering (SRE) teams.

### BRIEF DESCRIPTION OF THE FIGURES

A more detailed understanding of the present invention may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“Figs.”) indicate like elements, and wherein:

FIG. 1 is a system diagram showing an exemplary network computing environment in which the present invention may be employed;

FIG. 2A is a schematic block diagram illustrating an exemplary and non-limiting embodiment of a computerized Dynamic Telemetry Agent Enabled Endpoint in accordance with embodiments of the present invention;

FIG. 2B is a schematic block diagram illustrating an exemplary and non-limiting embodiment of a computerized Dynamic Telemetry Agent Management System in accordance with embodiments of the present invention;

FIG. 3 is a flow diagram illustrating operation of the system in accordance with an exemplary and non-limited embodiment of the present invention;

FIGS. 4A, 4B, 4C, and 4D illustrate exemplary graphical user interface windows providing a low-code/no-code agent configuration interface in accordance with an exemplary embodiment of the present invention, showing a visual drag-and-drop interface for configuring a telemetry agent; and

FIGS. 5A and 5B illustrate exemplary graphical user interface windows providing a low-code agent configuration interface in accordance with an exemplary embodiment of the present invention, showing a data input interface for receiving data for configuring a telemetry agent.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

The present invention provides a system and method that allows for easier creation and/or configuration of telemetry agents, and therefore lessens the need for use of skilled software developer human resources. Additionally, the present invention provides a system and method that allows for flexibility in system monitoring and/or telemetry data management. More particularly, the present invention provides a system and method that provides a low-code and/or no-code visual designer graphical user interface usable by laypersons to create and/or configure telemetry data management agents that govern data collection, storage, transmission, etc. at a computerized endpoint device (e.g., a computerized device including conventional data processing and communication hardware and software, such as Windows, MacOS, Linux, or other conventional operating system software).

Further, the present invention comprises a system and method that provides for dynamic updating of disparate endpoint hardware to modify the nature and/or quantity of telemetry data collected and/or otherwise manage telemetry data storage, transmission, etc., by allowing for dynamic updating of deployed telemetry data management agents-even after initial deployment of such agents.

Accordingly, the present invention reduces the need for skilled software developer human resources to perform these functions, and empowers others that are not skilled software developers, such as layperson members of the Operations, DevOps, and Site Reliability Engineering (SRE) teams.

Additionally, for example, data sampling and/or collection can be increased at certain times to aid in troubleshooting during a partial outage of other system problem, and yet may be decreased at other times of normal operation to provide a balanced approach to management of large volumes of data, while also providing an increased volume of information when needed most. Additionally, for example, dynamic telemetry agent management allows for the agent to be configured over time, even after deployment to an endpoint, to vary any aspect of telemetry data collection, storage, transmission etc.—e.g., to vary the sources of data collected, to filter data, to increase/decrease data collection, allow for handling of ad hoc data queries, etc. This can also allow, for example, for data to be filtered/processed or otherwise handled at the endpoint before transmitting it to the centralized system and into the monitoring system's data observability pipeline. More particularly, the telemetry agent can be configured to temporarily buffer data locally and send data to the centralized system only when needed so that, for example, data does not need to be collected continuously at the centralized system (which is resource-intensive) and yet can be available when needed (e.g., in the event of an outage or other problem).

As is well-known in the art, such telemetry agents (including associated plug-ins) are configured by way of configuration files that are used at endpoints or otherwise in associate with the telemetry agents to manage telemetry data collection, storage, transmission to a centralized system, etc. at/from an endpoint device. As known in the art, plug-ins are software-based modules that provide units of functionality that conform to a given function within the telemetry agent. Input plug-ins collect data, processor plug-ins process data, output plug-ins output data to various sources. These plug-ins are composable, so there can be unique combinations and configurations of the plug-ins for a given telemetry agent having specific functionality. The inventive system provides a low-code agent configuration graphical user interface that is a low-code environment usable to select, associate, and/or configure plug-ins, and to thereby build and configure a suitable data telemetry agent by creating a configuration file that configures plug-ins. Thereby, it provides and configures a data telemetry agent without the need to write configuration files. Instead, it creates suitable configurations using a visual (e.g., graphical, such as drag-and-drop) interface to assemble, associate and configure user-manipulable graphical user interface elements (e.g., widgets) into a data pipeline model that is used by the system to create corresponding software code usable as a configuration file to configure/customize a conventional telemetry agent that follows the plug-in pipeline model and is controlled through the use of configuration files for use at a conventional endpoint hardware. In other words, the inventive builder graphical user interface produces configuration blocks for each plug-in, that, when taken together, make up the telemetry agent configuration file.

Further, the inventive system makes use of an Agent Manager, which is additional code that is deployed to each endpoint and that is operable to check for, request, receive, store, and/or initiate restart to implement new/updated configurations files created via the agent configuration graphical user interface. In one exemplary embodiment, the Agent Manager is operable at each endpoint to repetitively poll a centralized component of the system, e.g., Dynamic Telemetry Agent Management System (DTAMS) 300, for newly-developed telemetry agent configuration files, retrieve them from a centralized system when available (e.g., when created using the low-code environment), and store them at the endpoint device for use on a next startup or refresh of the telemetry data management process at the endpoint device, which may be initiated by the Agent Manager for force a refresh implementing the new configuration file. More particularly, conventional endpoints and telemetry data management processes routinely check for associated configuration files at various points in time. The Agent Manager acts to ensure that any newly available configuration file is retrieved, stored, and available for use the next time that the endpoint and/or telemetry data management process is started, so that the new configuration effectively replaces the prior configuration, and so that the telemetry agent is not static after deployment to the field/a remote endpoint, but rather is reconfigurable and refreshed after deployment, and thus can be updated/changed dynamically, over time.

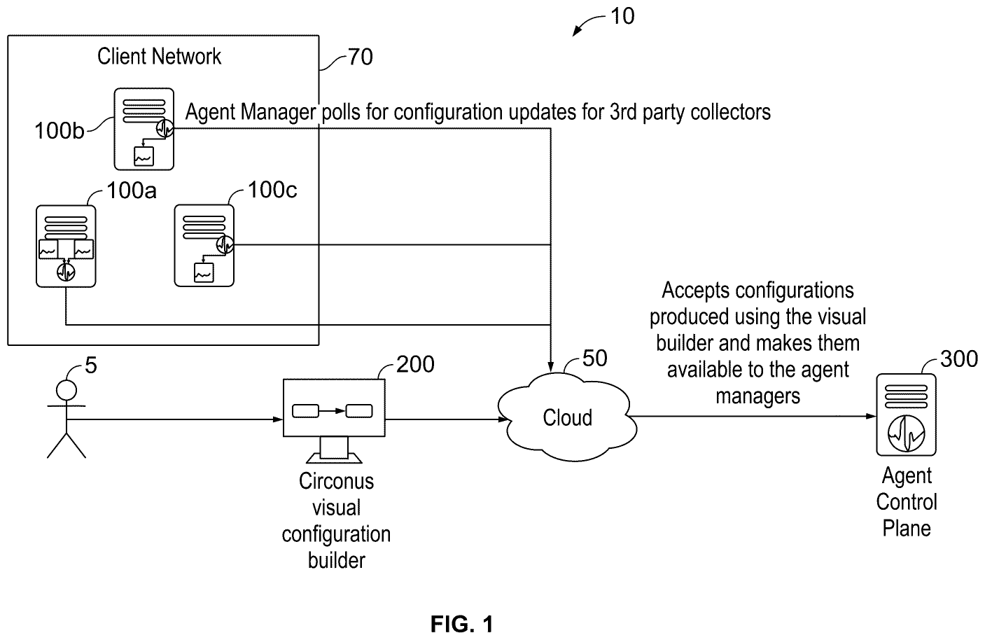

According to illustrative embodiment(s) of the present invention, various views are illustrated in FIGS. 1-6 and like reference numerals are used consistently throughout to refer to like and/or corresponding parts of the invention for all of the various views and figures of the drawings.

The following detailed description of the invention contains many specifics for the purpose of illustration. Anyone of ordinary skill in the art will appreciate that many variations and alterations to the following details are within the scope of the invention. Accordingly, the following implementations of the invention are set forth without any loss of generality to, and without imposing limitations upon, the claimed invention.

### System Environment

An exemplary embodiment of the present invention is discussed below for illustrative purposes. FIG. 1 is a system diagram showing an exemplary network computing environment 10 in which the present invention may be employed. As shown in FIG. 1, the exemplary network environment 10 includes certain conventional computing hardware and software for communicating via a communications network 50, such as the Internet, etc. It further includes a Dynamic Telemetry Agent Enabled Endpoint (DTAEE) 100a, 100b, 100c disposed within one or more Client Networks 70, and/or a Dynamic Telemetry Agent Configuration System (DTACS) 200 and/or a Dynamic Telemetry Agent Management System (DTAMS) 300, each of which may be, for example, one or more personal computers/PCs, laptop computers, tablet computers, smartphones, or other computing system hardware, including computerized/networked communication hardware/software/functionality, such as computer-based servers and the like, or other so-called “connected” communication devices having communication capabilities for communicating data via the network, in any form, such as any computerized and/or internet-of-things type device.

In accordance with a certain aspect of the present invention, a user 5 may operate the Dynamic Telemetry Agent Configuration System (DTACS) 200, which is a computing device providing a graphical user interface (e.g., via a Software as a Service (SaaS) platform in conjunction with DTAMS 300 or otherwise) in accordance with the present invention that is operable to build and/or configure a dynamic telemetry agent (software code and/or configuration files) that can be deployed to the field (e.g., for installation on or in association with remotely-located endpoint hardware that provides telemetry data for monitoring purposes, etc.). In essence, the DTACS 200 can be almost any computer, tablet, smartphone, or other type of computing device that is capable of communicating, e.g., over a network, with the DTAMS 300 to interface with the SaaS at the DTAMS 300. The resulting dynamic telemetry agent may be communicated to and stored at the DTAMS 300 via the network 50 (for later transmission by the DTAMS 300 to the DTAEEs 100, where they will be deployed.

In accordance with another aspect of the present invention, dynamic telemetry agents are provided as plug-in based telemetry agents that are controlled by novel Agent Manager software provided in accordance with the present invention. Separate Agent Manager software in accordance with the present invention is transmitted from the DTAMS 300 to one or more DTAEEs 100a, 100b, 100c via the network 50. More particularly, the Agent Manager is installed as a separate application on the target endpoint device and is completely external to the telemetry agents. It functions to check if there are new configurations (configuration files) available for the telemetry agents it manages, store those files at the correct place on disk/in memory, and trigger the telemetry agent to adopt the new configuration by using the new configuration file.

Thus, in accordance with the present invention, the Agent Manager software is separate and distinct from the conventional data telemetry agents/plug-ins that it manages. In certain embodiments, one Agent Manager may manage multiple telemetry agents.

The Agent Manager software is configured to repeatedly communicate with the DTAMS 300 to identify any new configuration file that is applicable to the relevant endpoint and/or Agent Manager instance, retrieve the new configuration file, and store the new configuration file at the corresponding endpoint (or in an otherwise suitable location) such that the associated telemetry agent will reference the new configuration file, instead of the old configuration file, thereby updating the telemetry agent and/or endpoint in accordance with new configuration parameters (and/or instructions captured in the new configuration file).

The transmission of the Agent Manager as well as the transmission of the updates to the configuration files from the DTAMS 300 to the one or more DTAEEs 100a, 100b, 100c can be achieved via any conventional mechanism for communicating data from one computing device to another via a network (or otherwise). Hardware and software for enabling communication of data by computing systems via such communications networks are well known in the art, and thus are not discussed in detail herein.

### Dynamic Telemetry Agent Enabled Endpoint

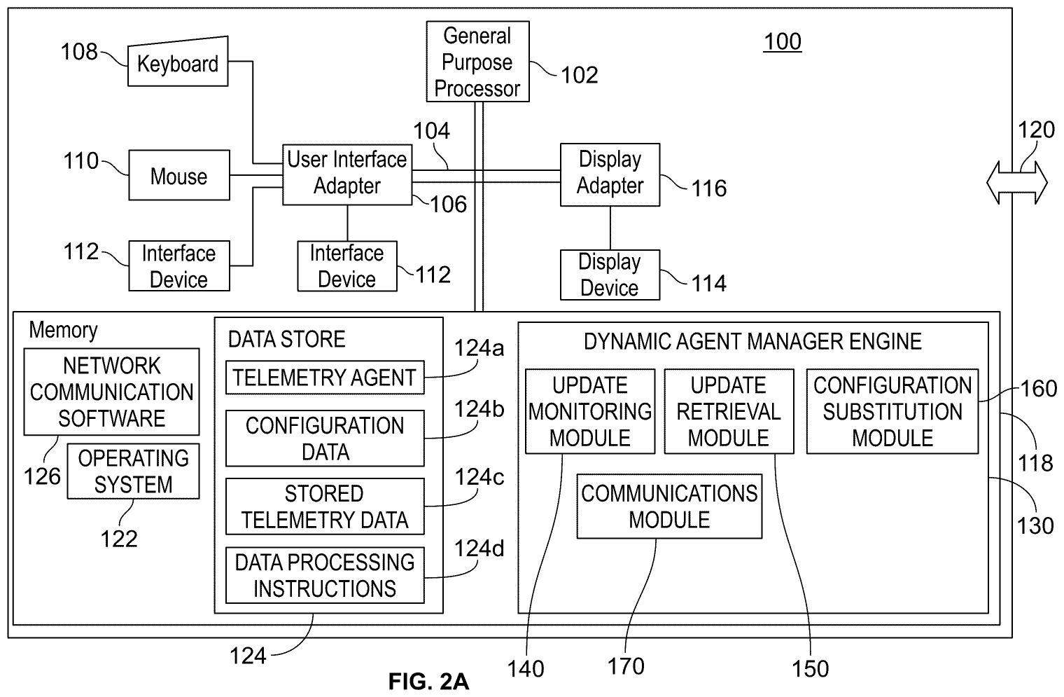

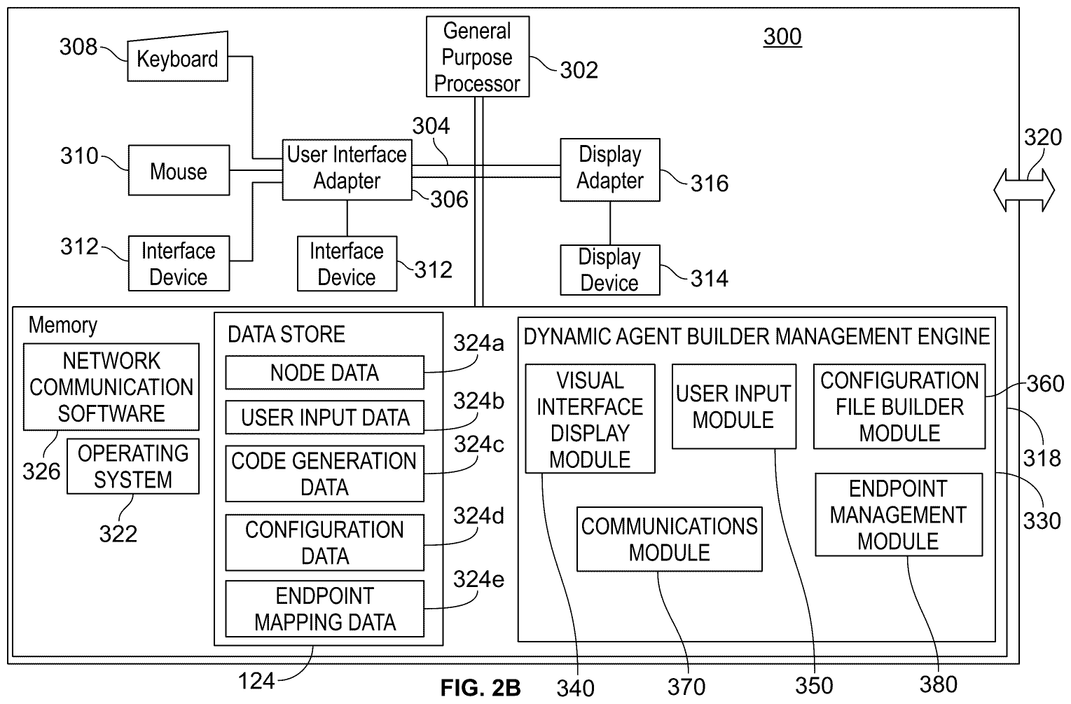

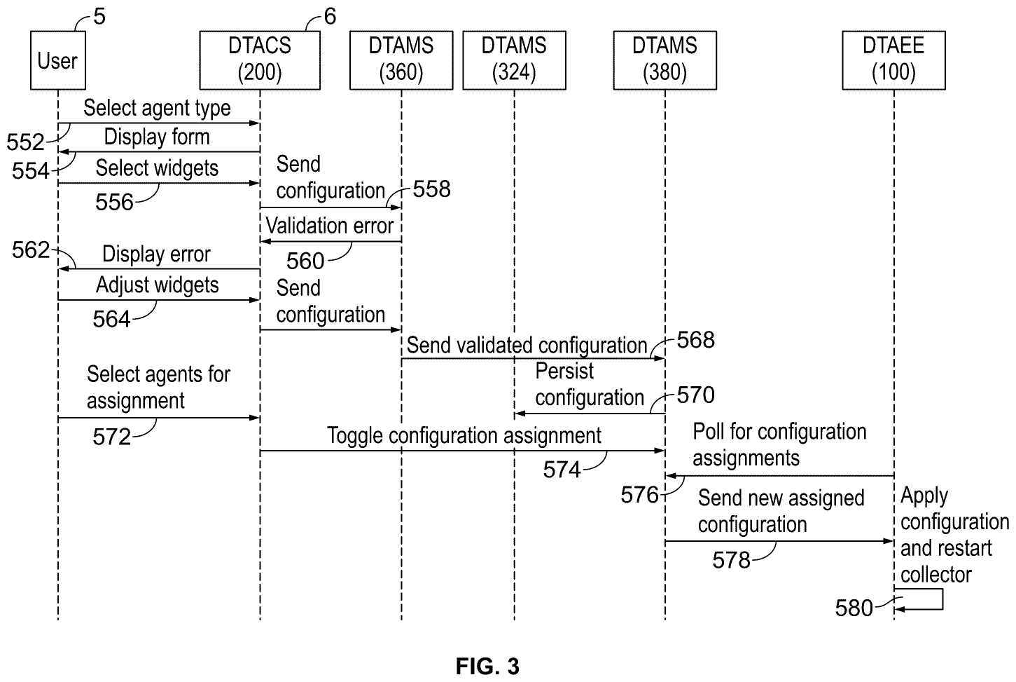

FIG. 2A is a schematic block diagram showing an exemplary Dynamic Telemetry Agent Enabled Endpoint (DTAEE) 100/100a/100b/100c in accordance with an exemplary embodiment of the present invention in greater detail. The exemplary DTAEE 100 is a special-purpose computer system that includes conventional computing hardware storing and executing both conventional computing software enabling operation of a general-purpose computing system, such as operating system software, network communications software, etc., and specially-configured computer software for carrying out at least one method in accordance with the present invention. By way of example, the communications software may include conventional web server software, and the operating system software may include iOS, Android, Windows, Linux software, etc.

In some embodiments, the DTAEE 100 may, for example, execute, process, facilitate, and/or otherwise be associated with the embodiments and methods described herein.

Accordingly, the exemplary DTAEE 100 of FIG. 2A includes a general-purpose processor, such as a microprocessor (CPU), 102 and a bus 104 employed to connect and enable communication between the processor 102 and the components of the system in accordance with known techniques. According to some embodiments, the processor 102 may be or may include any type, quantity, and/or configuration of processor that is or becomes known. In some embodiments, the processor 102 may comprise multiple inter-connected processors, microprocessors, and/or micro-engines. According to some embodiments, the processor 102 (and/or the system 100 and/or other components thereof) may be supplied power via a power supply (not shown), such as a battery, an Alternating Current (AC) source, a Direct Current (DC) source, an AC/DC adapter, solar cells, and/or an inertial generator. By way of example, the system 100 may comprise consumer-grade endpoint hardware/software (such as desktop computers running conventional operating system software), or a server, such as a blade server, and necessary electrical power may be supplied via a standard AC outlet, power strip, surge protector, and/or Uninterruptible Power Supply (UPS) system.

This exemplary DTAEE 100 includes a user interface adapter 106, which connects the processor 102 via the bus 104 to one or more interface devices, such as a keyboard 108, mouse 110, and/or other interface devices 112, which can be any user interface device, such as a touch-sensitive screen, digitized entry pad, etc. The bus 104 also connects a display device 114, such as an LCD screen or monitor, to the processor 102 via a display adapter 116. Certain endpoint hardware may not include one or more of these items, as will be appreciated by those skilled in the art.

The bus 104 also connects the processor 102 to memory 118, which may comprise a hard drive, a solid-state drive or memory, an optical drive, a diskette drive, a tape drive, etc. The memory 118 may comprise any appropriate information storage system that is or becomes known or available, including, but not limited to, units and/or combinations of magnetic storage systems (e.g., a hard disk drive), optical storage systems, and/or semiconductor memory systems, such as RAM systems, Read Only Memory (ROM) systems, Single Data Rate Random Access Memory (SDR-RAM), Double Data Rate Random Access Memory (DDR-RAM), and/or Programmable Read Only Memory (PROM).

The memory 118 may, according to some embodiments, store one or more software components. Any or all of the exemplary instructions and data types described herein and other practicable types of data may be stored in any number, type, and/or configuration of memory systems that is or becomes known. The memory 118 may, for example, comprise one or more data tables or files, databases, table spaces, registers, and/or other storage structures. In some embodiments, multiple databases and/or storage structures (and/or multiple memory systems) may be utilized to store information associated with the system 100. According to some embodiments, the memory 118 may be incorporated into and/or otherwise coupled to the system 100 (e.g., as shown) or may simply be accessible to the system 100 (e.g., externally located and/or situated).

The DTAEE 100 may communicate with other computers or networks of computers, for example via a communications channel, network card, modem or transceiver (collectively, “transceiver”) 120. In some embodiments, the transceiver 120 may comprise any type or configuration of communication system that is or becomes known or practicable. The transceiver 120 may, for example, comprise a Network Interface Card (NIC), a telephonic system, a cellular network system, a router, a hub, a modem, and/or a communications port or cable.

According to some embodiments, the transceiver 120 may be additionally or alternatively coupled to the processor 102. In some embodiments, the transceiver 120 may comprise an InfraRed (IR), Radio Frequency (RF), Bluetooth™, Near-Field Communication (NFC), and/or Wi-Fi® network system coupled to facilitate communications between the processor 102 and another system (not shown). The DTAEE 100 may be associated with such other computers in a local area network (LAN) or a wide area network (WAN), and may operate as a server in a client/server arrangement with another computer, etc. Such configurations, as well as the appropriate communications hardware and software, are known in the art.

In the embodiment shown in FIG. 2A, the DTAEE 100 is specially configured in accordance with the present invention. Particularly, the DTAEE 100 includes computer-readable, processor-executable instructions stored in the memory 118 for carrying out the methods described herein. Further, the memory 118 stores certain data, e.g., in one or more databases or other data stores shown logically in FIG. 2A at 124 for illustrative purposes, without regard to any particular embodiment in one or more hardware or software components.

Further, the DTAEE 100 includes a Dynamic Agent Manager Engine (DAME) 130, shown schematically as stored in the memory 118 (but which may be stored in any memory location), which includes a number of additional modules providing functionality in accordance with the present invention. These modules may be implemented primarily by specially-configured software including microprocessor-executable instructions stored in the memory 118 of the DTAEE 100. Further, the DAME 130 includes one or more modules shown logically in FIG. 2A for illustrative purposes, without regard to any particular embodiment in one or more hardware or software components.

Although the terms “step”, “block”, “module”, “engine”, etc. might be used herein to connote different logical components of methods or systems employed and/or for ease of illustration, the terms should not be interpreted as implying any particular order among or between various steps herein disclosed unless and except when the order of individual steps is explicitly described or inherently required, or be interpreted as implying any distinct structure separate and apart from other structures of the system.

The DAME 130 includes an Update Monitoring Module 140 that is operable to check for new/updated configuration files usable by a telemetry data management agent 124, e.g., by actively polling (e.g., using HTTPS) the DTAMS 300 to identify any new/updated configuration file applicable to the relevant endpoint and/or Agent Manager instance. Alternatively, the DTAMS 300 may be configured to distribute such new/updated confirmation files without active polling, in which case the DAME 130 may receive such a file passively.

The DAME 130 also includes an Update Retrieval Module 150 that is operable to retrieve the new/updated configuration file (e.g., from the DTAMS 300), e.g., using a pull distribution model or a push distribution model, though a pull model may be preferred in view of endpoint security measures. This may be performed by the Update Retrieval Module 150 acting in concert with the Communications Module 170, which may be configured to manage communications via the network.

In this embodiment, the DAME 130 also includes a Configuration Substitution Module 160 that is operable to store the new configuration file at the corresponding endpoint (e.g., as Configuration Data 124b in data store 124) or otherwise in a suitable location such that the associated agent (e.g., Telemetry Agent 124a stored in data store 124) will reference the new/updated configuration file stored as Configuration Data 124b instead of the old configuration file, thereby updating the telemetry agent and/or endpoint in accordance with new configuration parameters and/or instructions captured in the new configuration file.

DTAEE 100 may also store Telemetry Agent data 124a in the memory, which may include processor-executable instructions, and which may be entirely conventional agent plug-ins/software/code/instructions. The configuration data and/or the Telemetry Agent 124a may be configured (a) to store telemetry data locally (shown as Stored Telemetry Data 124c) and/or (b) to process the telemetry data at the DTAEE 100, e.g., in accordance with stored processor-executable Data Processing Instructions 124d. It may be further configured to communication the telemetry data and/or the results of such processing in accordance with configuration settings captured in the current Configuration Data 124 to the DTAMS 300, by operation of the Telemetry Agent 124a and Communications Module 170.

Accordingly, this configuration allows for dynamic updating (i.e., post-initial deployment) of an endpoint, telemetry agent, and/or telemetry agent configuration file, by providing an automated mechanism to retrieving new configuration files that effectively update the endpoint and/or telemetry agent and thereby update the data collection, storage, transmission, etc. associated with monitoring of that endpoint.

### Dynamic Telemetry Agent Management System

FIG. 2B is a schematic block diagram showing an exemplary Dynamic Telemetry Agent Management System (DTAMS) 300 in accordance with an exemplary embodiment of the present invention. The exemplary DTAMS 300 is a special-purpose computer system that includes conventional computing hardware storing and executing both conventional computing software enabling operation of a general-purpose computing system, such as operating system software, network communications software, etc., and specially-configured computer software for carrying out at least one method in accordance with the present invention. By way of example, the communications software may include conventional web server software, and the operating system software may include iOS, Android, Windows, Linux software, etc.

FIG. 2B is a block diagram of an exemplary DTAMS 300 according to some embodiments. In some embodiments, the DTAMS 300 may, for example, execute, process, facilitate, and/or otherwise be associated with the embodiments and methods described herein.

The exemplary DTAMS 300 of FIG. 2B includes a general-purpose processor, such as a microprocessor (CPU), 302 and a bus 304 employed to connect and enable communication between the processor 302 and the components of the system in accordance with known techniques. According to some embodiments, the processor 302 may be or may include any type, quantity, and/or configuration of processor that is or becomes known. In some embodiments, the processor 302 may comprise multiple inter-connected processors, microprocessors, and/or micro-engines. According to some embodiments, the processor 302 (and/or the system 300 and/or other components thereof) may be supplied power via a power supply (not shown), such as a battery, an Alternating Current (AC) source, a Direct Current (DC) source, an AC/DC adapter, solar cells, and/or an inertial generator. In the case that the system 300 comprises a server, such as a blade server, necessary power may be supplied via a standard AC outlet, power strip, surge protector, and/or Uninterruptible Power Supply (UPS) system.

This exemplary DTAMS 300 includes a user interface adapter 306, which connects the processor 302 via the bus 304 to one or more interface devices, such as a keyboard 308, mouse 310, and/or other interface devices 312, which can be any user interface device, such as a touch-sensitive screen, digitized entry pad, etc. The bus 304 also connects a display device 314, such as an LCD screen or monitor, to the processor 302 via a display adapter 316. Certain endpoint hardware may not include one or more of these items, as will be appreciated by those skilled in the art.

The bus 304 also connects the processor 302 to memory 318, which may comprise a hard drive, a solid-state drive or memory, an optical drive, a diskette drive, a tape drive, etc. The memory 318 may comprise any appropriate information storage system that is or becomes known or available, including, but not limited to, units and/or combinations of magnetic storage systems (e.g., a hard disk drive), optical storage systems, and/or semiconductor memory systems, such as RAM systems, Read Only Memory (ROM) systems, Single Data Rate Random Access Memory (SDR-RAM), Double Data Rate Random Access Memory (DDR-RAM), and/or Programmable Read Only Memory (PROM).

The memory 318 may, according to some embodiments, store one or more software components. Any or all of the exemplary instructions and data types described herein and other practicable types of data may be stored in any number, type, and/or configuration of memory systems that is or becomes known. The memory 318 may, for example, comprise one or more data tables or files, databases, table spaces, registers, and/or other storage structures. In some embodiments, multiple databases and/or storage structures (and/or multiple memory systems) may be utilized to store information associated with the system 300. According to some embodiments, the memory 318 may be incorporated into and/or otherwise coupled to the system 300 (e.g., as shown) or may simply be accessible to the system 300 (e.g., externally located and/or situated).

The DTAMS 300 may communicate with other computers or networks of computers, for example, via a communications channel, network card, modem or transceiver (collectively, “transceiver”) 320. In some embodiments, the transceiver 320 may comprise any type or configuration of communication system that is or becomes known or practicable. The transceiver 320 may, for example, comprise a Network Interface Card (NIC), a telephonic system, a cellular network system, a router, a hub, a modem, and/or a communications port or cable.

According to some embodiments, the transceiver 320 may also or alternatively be coupled to the processor 302. In some embodiments, the transceiver 320 may comprise an IR, RF, Bluetooth™, Near-Field Communication (NFC), and/or Wi-Fi® network system coupled to facilitate communications between the processor 302 and another system (not shown). The DTAMS 300 may be associated with such other computers in a local area network (LAN) or a wide area network (WAN), and may operate as a server in a client/server arrangement with another computer, etc. Such configurations, as well as the appropriate communications hardware and software, are known in the art.

In the embodiment shown in FIG. 2B, the DTAMS 300 is specially configured in accordance with the present invention. Accordingly, as shown in FIG. 2B, the DTAMS 300 includes computer-readable, processor-executable instructions stored in the memory 318 for carrying out the methods described herein. Further, the memory 318 stores certain data, e.g., in one or more databases or other data store 324 shown logically in FIG. 2B for illustrative purposes, without regard to any particular embodiment in one or more hardware or software components.

Further, as will be noted from FIG. 2B, the DTAMS 300 includes, in accordance with the present invention, a Dynamic Agent Configuration and Management Engine (DACME) 330, shown schematically as stored in the memory 318, which includes additional modules providing functionality in accordance with the present invention, as discussed in greater detail below. These modules may be implemented primarily by specially-configured software including microprocessor-executable instructions stored in the memory 318 of the DTAMS 300. Optionally, other software may be stored in the memory 318 and and/or other data may be stored in the data store 324 or memory 318. Further, the DAME 130 includes one or more modules shown logically in FIG. 2B for illustrative purposes, without regard to any particular embodiment in one or more hardware or software components.

Although the terms “step”, “block”, “module”, “engine”, etc. might be used herein to connote different logical components of methods or systems employed and/or for ease of illustration, the terms should not be interpreted as implying any particular order among or between various steps herein disclosed unless and except when the order of individual steps is explicitly described or inherently required, or be interpreted as implying any distinct structure separate and apart from other structures of the system.

The exemplary DACME 330 includes a Visual Interface Display Module (VIDM) 340 that is operable to cause display of an agent configuration builder graphical user interface that is a low-code/no-code environment using a visual (e.g., graphical, such as drag-and-drop) interface to assemble and configure user-manipulable graphical user interface elements (e.g., widgets) to define nodes of a model of a data pipeline that is then used by the system to create corresponding software code usable as a configuration file for a telemetry data agent of a conventional endpoint. The VIDM 340 may do so by retrieving widget-defining data from Widget Data store 324a stored in the data store 324. For example, these may include widgets capable of defining additional data to be associated with the collected telemetry data as well as widgets that define the desired behavior of one or more plug-ins supported by the telemetry agent. The VIDM 340 may do so by operation in concert with the Communications Module 370 to transmit data via the network 50, e.g., to the Dynamic Telemetry Agent Configuration System (DTACS) 200.

The exemplary DBAME 330 also includes a User Input Module 350 that is operable to receive the user's inputs as entered in response to user interface display of the VIDM 340 (e.g., via the DTACS 200). This may be performed by the User Input Module (UIM) 350 acting in concert with the Communications Module 170, which may be configured to manage communications via the network. By way of example, the UIM 350 may receive input linking together individual widgets to define nodes of the model and/or receive data input as parameters or other configuration of one or more of the widgets/nodes. This user input may be stored as User Input Data 324b in the data store 324. Accordingly, stored User Input Data including a user-defined combination of widgets and user-entered parameter/configuration data can collectively define a desired configuration file model.

In this embodiment, the DACME 330 also includes a Configuration File Coding Module 360 that is operable to automatedly create/generate (i.e. “write”) corresponding software code that is representative of the desired configuration file model, and that itself is suitable for use as a configuration file (in a suitable format) for a telemetry data management agent 124A (e.g., such as a commercially-available telemetry data management agent”). The resulting configuration file may be stored as Configuration Data 324 in the data store 324.

In this embodiment, the DACME 330 also includes an Endpoint Management Module 380 that is operable to ensure that each Configuration Data file stored in the data store 324 is associated with or otherwise made available to one or more appropriate endpoints, by storing appropriate data as Endpoint Mapping Data 324e. For example, this may effectively comprise setting a flag for a particular endpoint in Endpoint Mapping Data store 324e, the set flag being an indicator for that endpoint that a new configuration file is stored in the Configuration Data 324d and should be retrieved by or otherwise disseminated to the corresponding endpoint (e.g., by acting in concert with the Communication Module 370). Inbound polling transmissions requesting new configuration files and/or outbound delivery transmissions for delivering new configuration files may be handled by the Endpoint Management Module 380 and Communications Module, acting in concert.

In certain embodiments, the components discussed above at the DTAMS 300 are used to deliver the visual interface for building configuration files at a remotely located DTACS 200, e.g., via a SaaS model. In alternative embodiments, the DTACS 200 may include some or all of the components described above of the DTAMS 300, so that the functionality is provided locally at the DTACS 200 instead of via a SaaS model.

### System Operation

Exemplary operation of the system of FIGS. 1-2B is discussed below with reference to the swim lane flow diagram 550 of FIG. 3.

Referring now to FIG. 3, it will be appreciated that an exemplary method of operation of a system in accordance with the present invention involves a user 5 interacting with a visual agent configuration builder graphical user interface 6 at the DTACS 200, e.g., provided by the VIDM 340 of the DACME 330. In this step, the user 5 can provide input via the DTACS 200 via data entry forms. For instance, as shown at 552, the user 5 may select an agent and/or plug-in type from an initial menu in the graphical user interface 6 to identify a particular telemetry data management agent and/or plug-in (having particular structure, requirements, etc.) that will be associated with the configuration file to be built. There are a number of widely available open source and proprietary software platforms for telemetry management, each having its own unique design properties, requirements, parameters, parameter names, programming paradigms, etc. Some of the more commonly known platforms include Telegraf, Open Telemetry, Filebeat, and Metricbeat. Thus, the system may provide a different form specifically adapted to each such platform/agent type.

In response to the selection of the agent type, at 554, the configuration builder graphical user interface 6 presents the user 5 with a form particularly designed for entering the telemetry configuration parameters for that particular type of telemetry agent and/or plug-in. The forms allow the user to specify and thereby create the configuration necessary to use a given plug-in for a given telemetry agent.

The user will fill out several forms throughout the course of constructing the final configuration file. This helps to define how the configuration file should be built, so that it will be compatible with the intended agent. Next, at 556, the user 5 can interact with the form on the visual user interface 6, e.g., provided by the VIDM 340 of the DACME 330, to define a configuration file model by associating widgets to form nodes in a model. User-selectable graphical elements may be displayed that can be dragged into a working field to build and define the mode.

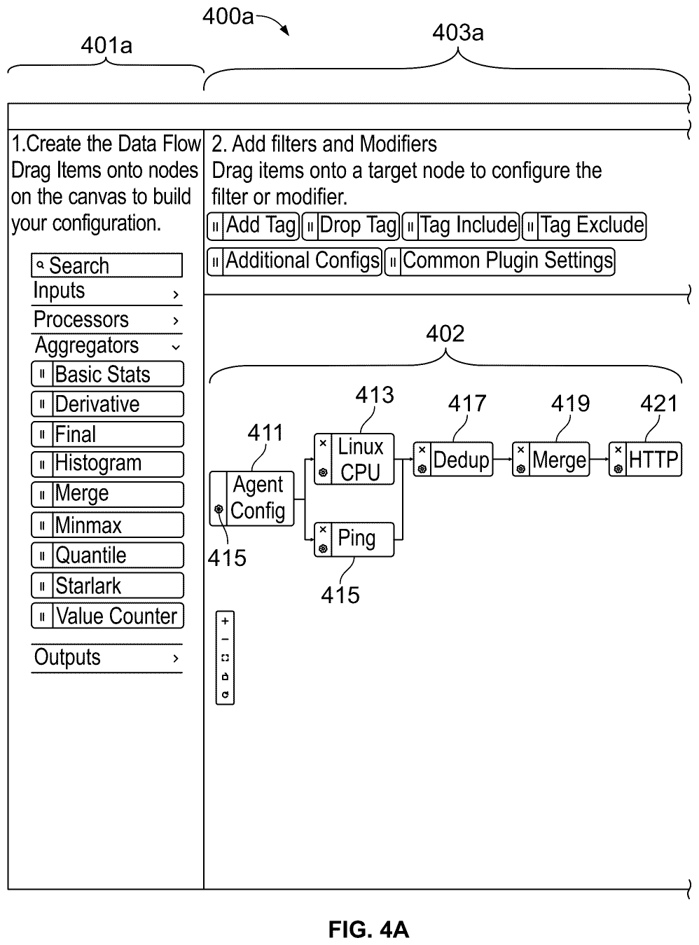

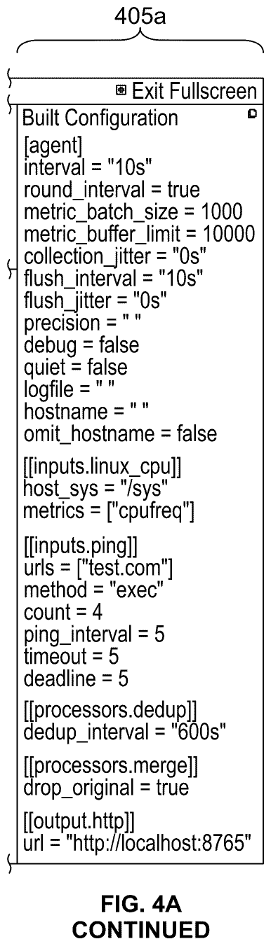

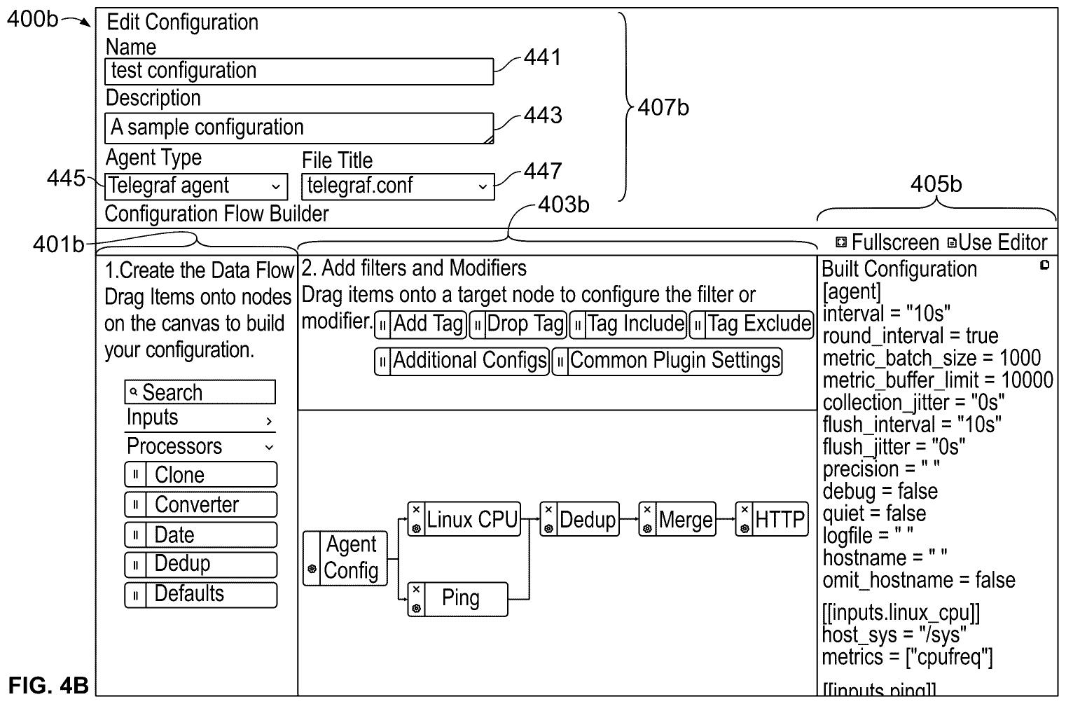

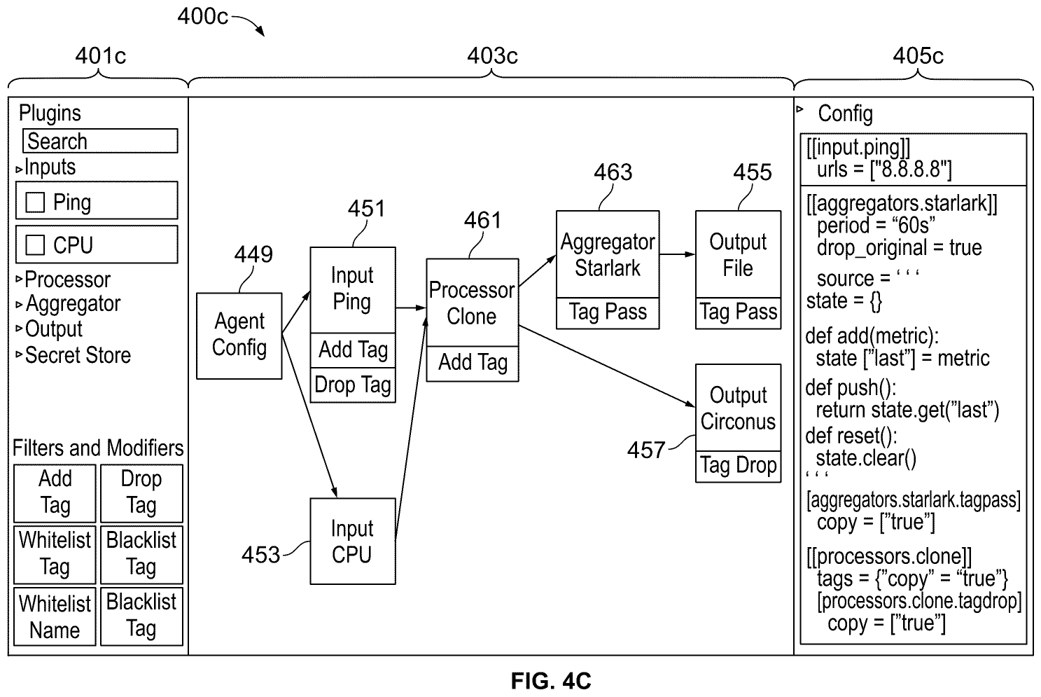

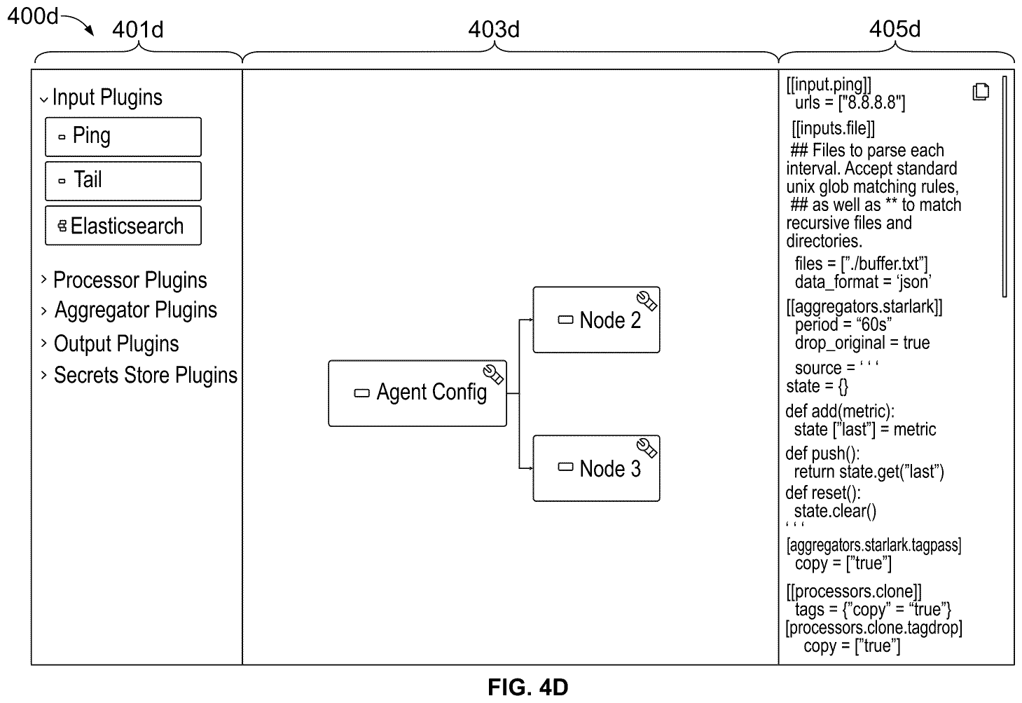

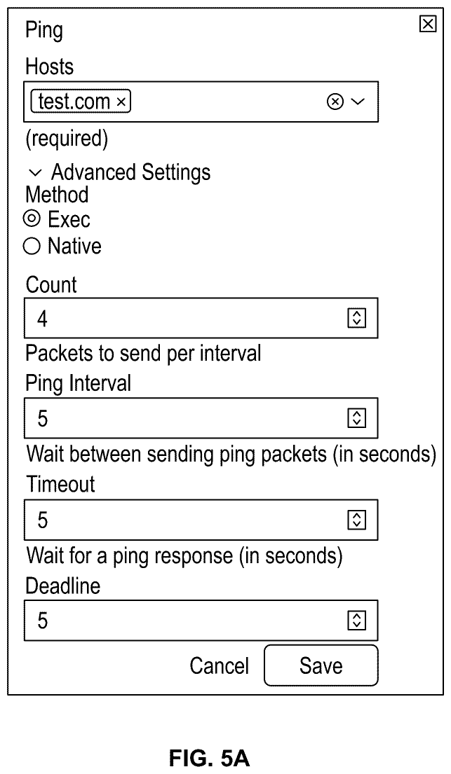

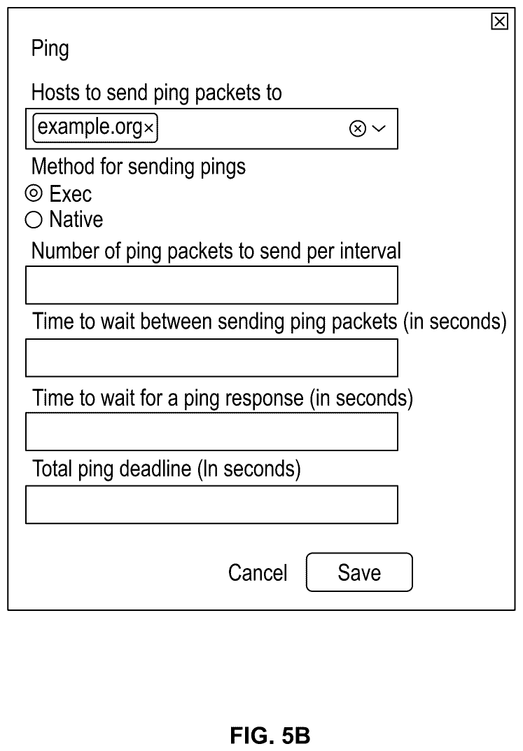

Exemplary graphical user interface windows 400 displaying exemplary widgets 410 linked as nodes 420 in configuration file models 430 are shown for illustrative purposes in FIGS. 4A-4D and 5A and B, which are discussed in detail further below. As will be described in more detail below, as part of this process, the VIDM 340 may display a graphical user interface window including fields for receiving user input of data, parameters, or other configuration information, e.g., as a function of the correction widget selected.

The configuration model effectively defines the data pipeline (i.e., the telemetry agent model) from the endpoint. By way of example, the configuration model (and file) can be configured to easily change telemetry types (e.g., metrics, logs, and traces), add new data sources (e.g., networks, applications and infrastructure), change data destinations, add filters to send only selected data and/or selected telemetry data types, to increase or decrease data collection intervals to generate more- or less-granular data, to activate and/or deactivate debug log filters, and to perform ad hoc queries that are too resource-intensive to be feasible to perform continuously.

Such dynamic management of telemetry agents in accordance with the present invention adds new capabilities to the field of telemetry, going beyond mere data collection, and further enabling innovative observability applications. For example, the present invention may be used to provide for intelligent edge processing that involves buffering high resolution data locally at the endpoint, and then sending data when needed for triage, assessment, etc. Further, the present invention may be used to dramatically reduce expensive log ingestion and to minimize alert fatigue by reducing the volume of reporting events and data. Further still, the present invention may be used to provide live view diagnostics such as top processes and collect other endpoint intelligence. Still further, the present invention may be used to selectively execute other “expensive” resource-intensive operations such as turning on a profiler or conducting synthetic user testing.

In certain embodiments, the Configuration File Coding Module 360 may be configured to provide real-time feedback on the validity of the user inputs and/or validate configurations to detect errors before they are deployed to endpoints, which reduces errors and instabilities in the operational system. For example, the Configuration File Coding Module 360 may perform webform validation to confirm that all webforms gathering data are completed and include the proper data types, e.g., an IP address and not text when an IP address is needed and expected. If there are one or more errors, the DTAMS 300 may send a message 560 back to the DTACS informing it of the error. The DTACS 200 can then generate a graphical user interface informing the user of the error as shown at 562. The user can then fix any errors and resubmit the corrected filled-in forms, as shown at 564. The DTACS 200 then forwards the corrected configuration information to the Configuration File Coding Module 360 at the DTAMS 300 for processing, as shown at 566 (this is essentially a repeat of 558, but with the modified configuration information.

If/when the Configuration File Coding Module 360 determines that the configuration information is valid/validated, it sends it to the Endpoint Management Module 3880 for processing the configuration information. The processing may include retrieval of code generation data 324c and/or data and generation of a valid, suitable configuration file usable by the intended agent, in the proper format, with the proper data, configuration parameters, etc. The resulting configuration file is then sent to the data store 324 for storage as Configuration Data 324d, as shown at 570.

Next, the VIDM 340 of the DTAMS 300 and/or DTACS 200 may display a graphical user interface window allowing the user 5 to select target telemetry agents (e.g., specific types of telemetry agents, or specific instances of agents on specific endpoints), as shown at 572. As previously mentioned, this may involve toggling a deployment flag associated with the particular target telemetry agent that is stored memory at the DTAMS 300 to a set condition, indicating that there is a new configuration file available for that telemetry agent. When the DTAMS eventually transmits the new configuration file to the target telemetry agent (and proper receipt thereof is confirmed), the flag can be reset. This is shown in FIG. 3 at 574, wherein the DTACS sends a message to the DTAMS to toggle the flag(s) corresponding to the affected telemetry agent(s) to a set condition (indicating that a new configuration file exists for that/those agent(s). This may be stored in the Endpoint Mapping Data 324e, and may be managed by the Endpoint Management Module 380. At this point, the new configuration file is ready and marked for distribution to the one or more relevant endpoints.

The Endpoint Management Module 380 may keep track of which telemetry agents are running which configurations via data stored in the Endpoint Mapping Data 324e.

Subsequently, the Update Monitoring Module 140 of the Dynamic Agent Manager Engine 130 of a DTAEE 100 may poll the DTAMS 300 to see if a new configuration file is available, e.g., for a particular agent or particular instance of an agent on an endpoint, as shown at 576. This polling request is received and managed by the Endpoint Management Module 380, and may be handled via an API of the DTAMS 300. The Endpoint Management Module 380, acting in concert with the Communications Module 370 and/or the Update Retrieval Module 150 of the DTAEE 100, subsequently responds by transmitting the corresponding configuration file from the Configuration Data 224d to the Dynamic Agent Manager Engine of a DTAEE 100, as shown at 578. The Dynamic Agent Manager Engine 130 (e.g., the Configuration Substitution Module 160) of the DTAEE 100 stores the new configuration file in an appropriate location for subsequent access by the associated telemetry agent 124a, and may initiate restarting of the endpoint and/or telemetry data collection process, as shown at 580 of FIG. 3, to initiate use of the new configuration file by the telemetry agent, and thus implement the functionality captured by the new configuration file.

FIGS. 4A, 4B, 4C, and 4D show four exemplary graphical user interface windows 400a, 400b, 400c, and 400d via which a user may enter a telemetry management configuration in a low-code/no-code manner that the system will convert into actual programming code to implement the configuration in an endpoint. In each of FIGS. 4A-4D, the left-hand portion 401a, 401b, 401c, and 401d comprises a collection of widgets that a user can select from and drag and drop into the middle portion 403a, 403b, 403c, and 403d of the interface to build a telemetry management model essentially in the form of a data pipeline or flowchart. As can be seen in the left-hand portions 401a, 401b, 401c, and 401d of those Figs., the widgets may be organized into groups, e.g., Input widgets, Process widgets, Aggregator widgets, and Output widgets, for ease of access by the user. In an example embodiment, Input type widgets allow the user to define sources from which to collect telemetry information. In an example, Processor widgets allow a user to define processes to be performed on the collected telemetry information. These may include processes such as annotating, modifying or otherwise adjusting the telemetry data. In an example, Aggregator widgets allow the user to aggregate the data in different ways. Particularly, the shear amount of telemetry can be daunting. Thus, it is often desirable to deduplicate data, discard redundant data (even if not exactly duplicative), organize data into groups, merge data, etc. In an example, Output widgets allow the user to define where the processed and aggregated data is to be sent/transmitted. It may be transmitted to a http address specified by the user within the widget or to another widget, etc.

Referring specifically to FIG. 4A, it shows a first example interface in which a user has constructed a particular telemetry management configuration/pipeline 402. In this scene, the user has the Aggregator type widgets expanded in the left-hand portion 401a of the interface to show the various Aggregator type widgets available to him/her for this particular agent type. Referring to the middle portion 403a of the interface, the user is constructing top level set of global configurations 411 for an agent. Telemetry data is to be collected from two different sources. As seen at 413, data is collected from a Linux CPU. As seen by widget 415, this pipeline also collects data via ping check, e.g., where it pings a particular URL to receive data.

Each widget may include a settings icon 414 that the user can click on in order to be presented with a new user interface within which the user can enter all of the relevant parameters for that particular widget. For instance, FIG. 5A shows the settings interface for Ping widget 413 in FIG. 4A. As can be seen in FIG. 5A, the user can specify a URL to ping, a method of pinging (via radio buttons), a window in which to enter a number of ping packets to be sent per a specified ping interval, a window for specifying the ping interval, a timeout interval defining a maximum wait time to receive a response to a ping, and a deadline period for completing a single ping session.

For exemplary purposes, FIG. 5B shows a different version of a ping widget settings user interface. In this particular case, the data elements to define the ping parameters are essentially the same as in FIG. 5A, but have different identifiers/names. This might be the case because one telemetry agent type may use different terminology than another type of telemetry agent for essentially the same information, and it is desirable to use the terminology consistent with the particular telemetry agent type to avoid the potential for confusing the user, who might be familiar with only one terminology set.

Referring again to FIG. 4A, next, the user has included a deduplication widget 417 in the pipeline to discard duplicate telemetry data. In this example, it is considered a Process widget, but could alternately be considered an Aggregator widget since deduplication could reasonably be considered a process of aggregating data.

In any event, the user has also included a merge widget 419 for merging certain types of data to make the overall data more manageable.

Finally, an output widget 421 for defining the destination for the processed aggregated telemetry data.

Each widget includes a settings icon that leads to another user interface, such as shown in FIGS. 5A and 5B, in which the user may enter the necessary parameters for that widget. The setting s user interface, of course, will be different for each different widget, since each different kind of widget may have different parameters that need to be defined for it. For instance, the settings interface for Output widget 421 may include windows for entering the address of the destination for the processed and aggregated data, the intervals as which such data is to be transmitted, etc.

FIG. 4B shows another user interface very similar to that shown in FIG. 4A, but further including a top portion 407b including data entry modules for entering additional general parameters such as (a) a Name for the model 441, (b) a Description for the Model 443, (c) the Telemetry Agent Type 445, and (d) a File Title for the final configuration file that will be generated by the system 447.

For exemplary purposes, FIG. 4C shows yet another user interface similar to FIGS. 4A and 4B in which the user is constructing a top level set of global configurations 449 for an agent with two input sources (i.e., two input widgets 451 and 453), but in which the pipeline has two different outputs 455 and 457 for two different types of data. Both data types run through the same Process (widget 461), but the top path includes an additional Aggregator widget 463 before the data is passed to the output widget 455, while the bottom path sends the data from Process widget 461 directly to Output widget 457.

FIG. 4D shows the user interface for one more example pipeline of a different type than shown and discussed above.

Finally, the right-hand portions 405a, 405b, 405c, and 405d of the four exemplary user interfaces of FIGS. 4A-4D comprise the actual computer code generated by the system responsive to the model configured in the middle portion by the user. The code will update each time the user adds a fully populated widget to the pipeline.

In certain embodiments, each widget may correspond to a piece of plug and play code stored in memory, wherein the process of building the code defining the telemetry pipeline based on the pipeline constructed by the user largely consists assembling the plug and play software modules in accordance with the pipeline.

In this manner, a new configuration file can be created remotely by a layperson using a low-code/no-code visual builder graphical user interface to build and configure a configuration file for use with a telemetry agent. That configuration file can be automatedly deployed to an appropriate endpoint for use by the endpoint's telemetry agent even after initial deployment of a telemetry agent to the endpoint, for subsequent data collection, storage, processing, transmission to a centralized telemetry system, write data to a file, send it to another service running on the server, etc., to allow for dynamic updating of disparate endpoint hardware using updates to already-deployed data management agents.

Additionally, the present system allows for the dynamic support of multiple different telemetry agents/plug-ins. In other words, the system of the present invention may be used to configure distinctly different types of plug-ins, despite the differences in formats, data requirements, and other variations among them. For instance, in an embodiment, the system may store several different user interfaces, e.g., a different one for each different type of telemetry agent/plug-in and present the user at the beginning of the reconfiguration process with a user interface in which the user selects the type of telemetry agent/plug-in that is being reconfigured. The system then presents the user with a file builder graphical user interface specifically designed for ease of use for reconfiguring a telemetry agent/plug-in of that particular type. Each such file builder graphical user interface is designed to make it easy and intuitive to produce a configuration file that will be properly structured, will contain the proper data, and thus will be valid for the selected agent/plug-in type.

### Conclusion

While there have been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs).

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the exemplary embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), quantum computer, and/or a state machine.

The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 items refers to groups having 1, 2, or 3 items. Similarly, a group having 1-5 items refers to groups having 1, 2, 3, 4, or 5 items, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Although the invention is illustrated and described herein with reference to specific embodiments, the invention is not intended to be limited to the details shown. Rather, various modifications may be made in the details within the scope and range of equivalents of the claims and without departing from the invention.

Throughout the disclosure, one of skill understands that certain representative embodiments may be used in the alternative or in combination with other representative embodiments.

What is claimed is:

1. A computer-readable device comprising non-transitory instructions, which, when executed by a processor, cause the processor to perform operations, the operations comprising:
generating a first graphical user interface for enabling a user to configure a telemetry data management software agent for monitoring telemetry in a network, the first graphical user interface being one of low-code and no-code;
receiving telemetry data management software agent configuration information via the user's interaction with the first graphical user interface;
converting the telemetry data management software agent configuration information into configuration computer code for configuring a telemetry data management software agent in accordance with the telemetry data management software agent configuration information;
storing the configuration computer code;
generating a second graphical user interface for enabling the user to identity at least one telemetry management agent in the network to which the configuration computer code is to be deployed;
storing data indicating the at least one telemetry management agent to which the configuration computer code is to be deployed; and
transmitting the configuration computer code to a network endpoint that included the at least one telemetry management agent.

2. The computer-readable code of claim 1 wherein the transmitting the configuration computer code comprises receiving from a network endpoint a query for any new configuration computer code for any telemetry management agent located at that network endpoint, wherein the transmitting the configuration computer code is performed responsive to receiving of the query.

3. The computer-readable code of claim 1 wherein the telemetry data management software agent configuration information comprises at least one of a telemetry type to be collected, a data source from which telemetry data is to be collected, a data destination to which telemetry data is to be transmitted, a filter defining particular data to be transmitted by the at least one telemetry management agent, a filter defining a particular data type to be transmitted by the at least one telemetry management agent, a data collection interval for collecting telemetry data, instructions to activate a debug log filter, instructions to deactivate a debug log filter, and instructions to perform an ad hoc telemetry query.

4. The computer-readable code of claim 1 wherein the telemetry data management software agent configuration information comprises instructions to store telemetry data at the endpoint and instructions when to transmit the stored telemetry data.

5. The computer-readable code of claim 1 wherein the telemetry data management software agent configuration information comprises instructions to conduct synthetic user testing.

6. The computer-readable code of claim 1 wherein the telemetry data management software agent configuration information comprises instructions to turn on a profiler.

7. The computer-readable code of claim 1 wherein the operations further comprise:
validating the telemetry data management software agent configuration information input by the user.

8. The computer-readable code of claim 7 wherein the operation of validating the telemetry data management software agent configuration information comprises confirming that all data entered by the user conforms to expected data types.

9. A method of dynamically reconfiguring telemetry data management software agents deployed at endpoints in a communication network, the method comprising:
generating a first graphical user interface for enabling a user to configure a telemetry data management software agent for monitoring telemetry in a network, the first graphical user interface being one of low-code and no-code;
receiving telemetry data management software agent configuration information via the user's interaction with the first graphical user interface;
converting the telemetry data management software agent configuration information into configuration computer code for configuring a telemetry data management software agent in accordance with the telemetry data management software agent configuration information;
storing the configuration computer code;
generating a second graphical user interface for enabling the user to identity at least one telemetry management agent in the network to which the configuration computer code is to be deployed;
storing data indicating the at least one telemetry management agent to which the configuration computer code is to be deployed; and
transmitting the configuration computer code to a network endpoint that included the at least one telemetry management agent.

10. The method of claim 9 wherein the transmitting the configuration computer code comprises receiving from a network endpoint a query for any new configuration computer code for any telemetry management agent located at that network endpoint, wherein the transmitting the configuration computer code is performed responsive to receiving of the query.

11. The method of claim 9 wherein the telemetry data management software agent configuration information comprises at least one of a telemetry type to be collected, a data source from which telemetry data is to be collected, a data destination to which telemetry data is to be transmitted, a filter defining particular data to be transmitted by the at least one telemetry management agent, a filter defining a particular data type to be transmitted by the at least one telemetry management agent, a data collection interval for collecting telemetry data, instructions to activate a debug log filter, instructions to deactivate a debug log filter, and instructions to perform an ad hoc telemetry query.

12. The method of claim 9 wherein the telemetry data management software agent configuration information comprises instructions to store telemetry data at the endpoint and instructions when to transmit the stored telemetry data.

13. The method of claim 9 wherein the telemetry data management software agent configuration information comprises instructions to conduct synthetic user testing.

14. The method of claim 9 wherein the telemetry data management software agent configuration information comprises instructions to turn on a profiler.

15. The method of claim 9 further comprising:
validating the telemetry data management software agent configuration information input by the user.

16. The method of claim 15 wherein validating the telemetry data management software agent configuration information comprises confirming that all data entered by the user conforms to expected data types.

17. A computer-readable device comprising non-transitory instructions, which, when executed by a processor, cause the processor to perform operations, the operations comprising:
transmitting a query for any new configuration computer code for a telemetry management agent;
receiving, responsive to the query, a configuration file for reconfiguring the telemetry management agent; and
reconfiguring the telemetry management agent in accordance with the received configuration file.

18. The computer-readable code of claim 17 wherein the telemetry data management software agent configuration information comprises at least one of a telemetry type to be collected, a data source from which telemetry data is to be collected, a data destination to which telemetry data is to be transmitted, a filter defining particular data to be transmitted by the at least one telemetry management agent, a filter defining a particular data type to be transmitted by the at least one telemetry management agent, a data collection interval for collecting telemetry data, instructions to activate a debug log filter, instructions to deactivate a debug log filter, and instructions to perform an ad hoc telemetry query.

19. The computer-readable code of claim 17 wherein the telemetry data management software agent configuration information comprises instructions to store telemetry data at the endpoint and instructions when to transmit the stored telemetry data.

20. The computer-readable code of claim 17 wherein the telemetry data management software agent configuration information comprises instructions to conduct synthetic user testing.
